(19) United States
(12) Patent Application Publication
(10) Pub. No.: US 2026/0140470 A1
(43) Pub. Date: May 21, 2026

(54) FIXING DEVICE AND IMAGE FORMING APPARATUS INCORPORATING THE SAME

(71) Applicant: Takuya SESHITA, Kanagawa (JP)

(72) Inventor: Takuya SESHITA, Kanagawa (JP)

(21) Appl. No.: 19/332,062

(22) Filed: Sep. 18, 2025

(30) Foreign Application Priority Data
Nov. 19, 2024 (JP) 2024-201226

(51) Int. Cl. G03G 15/20

(52) U.S. Cl. CPC G03G 15/206; G03G 15/2057; G03G 15/2064; G03G 2215/2025

(57) ABSTRACT

A fixing device includes a fixing rotator, a heater, a pressure roller pressed against the fixing rotator to form a nip, and a ring grounded. The pressure roller includes a shaft extending in an axial direction and a roller body. The roller body includes a conductive surface layer having an outer circumferential surface contacting the fixing rotator. The conductive surface layer has a folded portion folded from an edge of the outer circumferential surface toward the shaft in a radial direction of the shaft. The folded portion forms at least a part of a first end face of the roller body in the axial direction. The ring is disposed on the shaft. The ring has conductivity and a second end face along the first end face in the radial direction. The second end face contacts at least a part of the folded portion.

### CROSS-REFERENCE TO RELATED APPLICATION

This patent application is based on and claims priority pursuant to 35 U.S.C. § 119(a) to Japanese Patent Application No. 2024-201226, filed on Nov. 19, 2024, in the Japan Patent Office, the entire disclosure of which is hereby incorporated by reference herein.

### BACKGROUND

### Technical Field

The present disclosure relates to a fixing device that heats a toner image borne on the surface of a sheet to fix the toner image onto the sheet and an image forming apparatus including the fixing device, such as a copier, a printer, a facsimile machine, or a multifunction peripheral having at least two of copying, printing, and facsimile functions.

### Related Art

An image forming apparatus such as a copier or a printer in the related art includes a fixing device. The fixing device includes a pressure roller. Charge on the pressure roller is removed to prevent the occurrence of an abnormal image such as an electrostatic offset.

### SUMMARY

The present disclosure described herein provides a fixing device including a fixing rotator, a heater, a pressure roller, and a ring. The heater heats the fixing rotator. The pressure roller is pressed against the fixing rotator to form a nip through which a sheet is conveyed. The pressure roller includes a shaft extending in an axial direction and a roller body. The roller body includes a conductive surface layer having an outer circumferential surface contacting a surface of the fixing rotator at the nip. The conductive surface layer has a folded portion folded from an edge of the outer circumferential surface toward the shaft in a radial direction of the shaft. The folded portion forms at least a part of a first end face of the roller body in the axial direction. The ring is grounded and disposed on the shaft. The ring has conductivity and a second end face along the first end face in the radial direction. The second end face contacts at least a part of the folded portion.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIG. 2 is a diagram illustrating a configuration of a fixing device;

FIG. 3 is a schematic cross-sectional view of the fixing device of FIG. 2 to illustrate parts extending in an axial direction of a pressure roller;

FIG. 4 is a schematic cross-sectional view of a fixing belt and flanges of the fixing device of FIG. 3 in a cross-section perpendicular to the surface of the paper on which FIG. 3 is drawn;

FIG. 5 is a cross-sectional view of a fixing device connected to a ground path;

FIG. 6 is a cross-sectional view of an end of a part of the fixing device of FIG. 5 in the axial direction;

FIG. 7 is a cross-sectional view of a gear according to a first modification on an end of a pressure roller in the axial direction of the pressure roller;

FIG. 8 is a cross-sectional view of a gear according to a comparative example on the end of the pressure roller of FIG. 7;

FIGS. 9A to 9C are cross-sectional views of gears according to a second modification on the end of the pressure roller of FIG. 7;

FIG. 10A is a side view of folded portions according to a third modification on an end face of a pressure roller;

FIG. 10B is a side view of folded portions according to a comparative example on an end face of a pressure roller to compare the third modification; and

FIG. 11 is a cross-sectional view of an end of a pressure roller according to a fourth modification in an axial direction of the pressure roller.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to like elements or components and descriptions of those elements or components may be simplified or omitted.

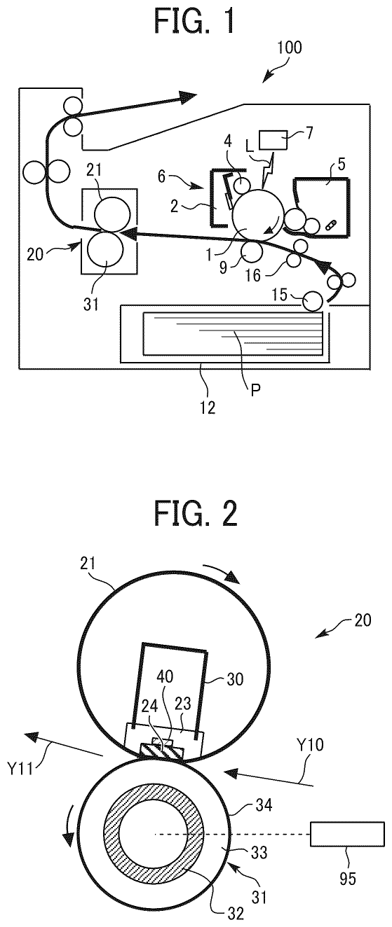

With reference to FIG. 1, the configuration and operation of an image forming apparatus 100 are described below.

In FIG. 1, the image forming apparatus 100 such as a small printer includes a process cartridge 6, an exposure device 7, a transfer roller 9, a sheet feeder 12, a registration roller pair 16 as a timing roller pair, and a fixing device 20. The process cartridge 6 is configured as a unit including a photoconductor drum 1, a charging roller 4, a developing device 5, and a cleaning device 2. The exposure device 7 irradiates the photoconductor drum 1 with exposure light L that is generated based on image data input from an input device such as a personal computer. A toner image is formed on the photoconductor drum 1. The sheet feeder 12 includes a feed tray to store sheets P. The registration roller pair 16 conveys a sheet P toward a transfer nip where the photoconductor drum 1 and the transfer roller 9 contact each other. The transfer roller 9 transfers the toner image borne on the surface of the photoconductor drum 1 onto the sheet P conveyed to the transfer nip (that is, a transfer position). The fixing device 20 fixes the toner image that has not yet been fixed, to the sheet P.

The charging roller 4, the developing device 5, and the cleaning device 2 are arranged around the photoconductor drum 1. These members (the photoconductor drum 1, the charging roller 4, the developing device 5, and the cleaning device 2) are integrated as the process cartridge 6 and are detachably (replaceably) attached to the body of the image forming apparatus 100 as the apparatus body. After a user uses the process cartridge 6 for a predetermined replacement cycle, the user removes the process cartridge 6 from the body of the image forming apparatus 100 and replaces the process cartridge 6 with a new one.

With reference to FIG. 1, typical processes of the image forming apparatus 100 are described below.

The input device such as the personal computer sends the image data to the exposure device 7 in the image forming apparatus 100, and the exposure device 7 irradiates the surface of the photoconductor drum 1 with the exposure light (a laser beam) L based on the image data.

A drive motor disposed in the body of the image forming apparatus 100 rotates the photoconductor drum 1 in the direction indicated by the arrow in FIG. 1 (clockwise). Initially, the charging roller 4 uniformly charges the surface of the photoconductor drum 1 at a position at which the surface of the photoconductor drum 1 faces the charging roller 4, which is referred to as a charging process. As a result, a charging potential (for example, approximately −900 V) is formed on the surface of the photoconductor drum 1. Subsequently, the charged surface of the photoconductor drum 1 reaches an irradiation position of the exposure light L. An electric potential at the position that receives the exposure light L changes to a latent image potential (about 0 to −100 V), and an electrostatic latent image is formed on the surface of the photoconductor drum 1, which is called an exposure process.

After the exposure process, the surface of the photoconductor drum 1 on which the electrostatic latent image is formed reaches the position facing the developing device 5. The developing device 5 supplies toner onto the photoconductor drum 1 to develop the electrostatic latent image on the photoconductor drum 1 into a toner image, which is referred to as a developing process.

After the developing process, the surface of the photoconductor drum 1 bearing the toner image reaches a transfer nip (that is, a transfer position) formed between the photoconductor drum 1 and the transfer roller 9. In the transfer nip, a transfer bias having a polarity opposite the polarity of the toner is applied from a power source to the transfer roller 9, thereby transferring the toner image formed on the photoconductor drum 1 onto the sheet P conveyed by the registration roller pair 16, which is referred to as a transfer process.

The surface of the photoconductor drum 1 after the transfer process reaches a position opposite the cleaning device 2. At the position opposite the cleaning device 2, a cleaning blade mechanically removes untransferred toner remaining on the surface of the photoconductor drum 1, and removed toner is collected in the cleaning device 2, which is referred to as a cleaning process.

Thus, a series of image forming processes on the photoconductor drum 1 is completed.

The sheet P is conveyed to the transfer nip between the photoconductor drum 1 and the transfer roller 9 as follows. First, a feed roller 15 feeds the uppermost sheet P of the stack of sheets P stored in the sheet feeder 12 toward a conveyance passage. Subsequently, the sheet P reaches the registration roller pair 16. The sheet P that has reached the registration roller pair 16 is conveyed to the transfer nip (the contact position of the transfer roller 9 with the photoconductor drum 1) in synchronization with an entry of the toner image formed on the photoconductor drum 1 into the transfer nip.

After the sheet P passes through the transfer nip (i.e., the position of the transfer roller 9) in the transfer process, the sheet P reaches the fixing device 20 through the conveyance passage. In the fixing device 20, the sheet P is interposed between a fixing belt 21 and a pressure roller 31. The toner image is fixed on the sheet P by heat applied from the fixing belt 21 and pressure applied from both of the fixing belt 21 and the pressure roller 31, which is referred to as a fixing process. After the sheet P having the fixed toner image thereon is ejected from the fixing nip formed between the fixing belt 21 and the pressure roller 31, the sheet P is ejected from the body of the image forming apparatus 100 and stacked on an output tray.

Thus, a series of the image forming processes is completed.

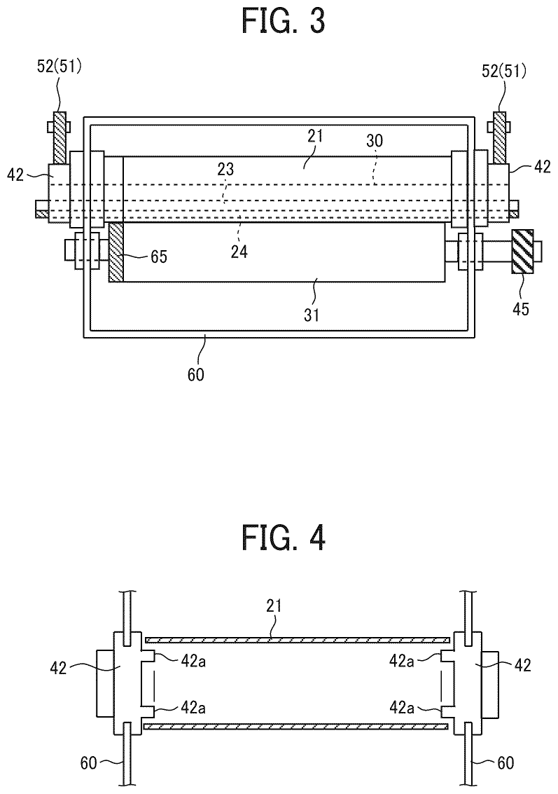

With reference to FIGS. 2 to 6, the following describes a configuration and operation of the fixing device 20. The fixing device 20 conveys the sheet P bearing an unfixed toner image while heating the sheet P. With reference to FIG. 2, the fixing device 20 includes the fixing belt 21 as a fixing rotator, a planar heater 24 as a heat source (a heating means), a holder 23, a stay 30, a thermistor 40, the pressure roller 31 as a pressure rotator, and a gear 65 as a ring (see FIGS. 3, 5, and 6).

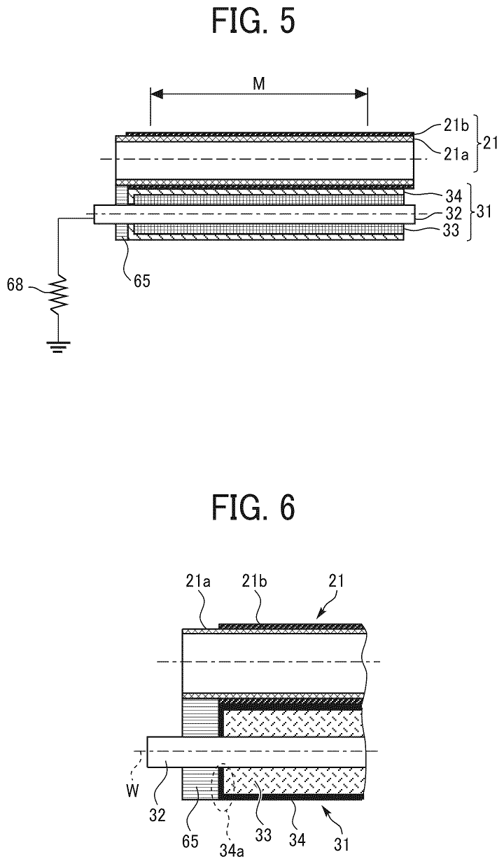

The fixing belt 21 is an endless belt disposed in contact with an outer circumferential surface of the pressure roller 31 and driven to rotate by rotation of the pressure roller 31. The fixing belt 21 is a thin, flexible endless belt driven to rotate clockwise in FIG. 2, that is, in a rotation direction indicated by an arrow in FIG. 2. With reference to FIG. 5, the fixing belt 21 includes a base layer 21a as a belt conductive layer having an inner circumferential surface (i.e., a sliding contact surface of the fixing belt 21 sliding over the planar heater 24) and a belt surface layer 21b as a surface layer having an insulating property (or medium resistance) and being layered on the base layer 21a. A total thickness of the fixing belt 21 is designed to be equal to or smaller than 1 mm.

The base layer 21a of the fixing belt 21 has a thickness in a range of from 30 μm to 50 μm. The base layer 21a is made of metal, such as nickel or stainless steel, or carbon-dispersed resin such as carbon-dispersed polyimide and functions as the belt conductive layer having conductivity.

The belt surface layer 21b of the fixing belt 21 has a thickness in a range of from 5 μm to 50 μm. The belt surface layer 21b is made of an insulating material such as tetrafluoroethylene-perfluoroalkyl vinyl ether copolymer (PFA), polytetrafluoroethylene (PTFE), polyimide, polyether imide, and polyether sulfone (PES). The belt surface layer 21b having the insulating property facilitates the separation of toner contained in the toner image on the sheet P from the fixing belt 21.

In the above, the belt surface layer 21b is made of an insulating material but may be made of a material having a medium resistance by dispersing a relatively small amount of carbon in the above-described insulating material. The specific resistance value range of the medium resistance is equal to or greater than 10⁷ Ω/□ and less than 10¹⁰ Ω/□. As a result, the belt surface layer 21b has a higher resistance larger than the base layer 21a as the belt conductive layer.

Inside the loop of the fixing belt 21, the planar heater 24, the holder 23, the stay 30, and the thermistor 40 are disposed

The planar heater 24 is disposed so as to extend in a width direction that is a direction perpendicular to the surface of the paper on which FIG. 2 is drawn, the lateral direction in each of FIGS. 3 to 6, and an axial direction of the pressure roller 31. The planar heater 24 contacts the inner circumferential surface of the fixing belt 21. The planar heater 24 is pressed against the pressure roller 31 via the fixing belt 21 to form the fixing nip through which the sheet P is conveyed. The planar heater 24 is disposed inside the loop formed by the fixing belt 21 such that the inner circumferential surface of the fixing belt 21 slides over the planar heater 24. Pressing the planar heater 24 against the pressure roller 31 via the fixing belt 21 forms the fixing nip between the fixing belt 21 and the pressure roller 31, through which the sheet P is conveyed. As described above, the planar heater 24 functions as a nip formation pad that is a member forming the fixing nip.

In addition, the planar heater 24 includes a resistor pattern (in other words, a resistive heat generator) formed on a portion that is in sliding contact with the inner circumferential surface of the fixing belt 21. A power supply supplies electric power to the resistor pattern, and the resistor pattern generates heat according to the resistance of the resistor pattern to heat the fixing belt 21. As described above, the planar heater 24 also functions as a heater to heat the fixing belt 21.

To reduce sliding friction between the inner circumferential surface of the fixing belt 21 and the planar heater 24, a lubricant such as silicon oil or fluorine grease is directly applied to the inner circumferential surface of the fixing belt 21. Instead of directly applying the lubricant to the inner circumferential surface of the fixing belt 21, the lubricant may be indirectly applied to the inner circumferential surface of the fixing belt 21 by applying the lubricant to the sliding contact surface of the planar heater 24 on which the fixing belt 21 slides. In addition to applying the lubricant to the inner circumferential surface of the fixing belt 21, the planar heater 24 may include a surface layer or a sheet made of a low friction material such as PTFE on the surface of the planar heater 24.

The holder 23 holds the planar heater 24. The holder 23 has a recess, and the planar heater 24 is fitted into the recess to hold the planar heater 24 in the width direction that is the axial direction.

The stay 30 holds the holder 23 holding the planar heater 24. The fixing device 20 includes a frame 60. The frame 60 holds both ends of the stay 30 holding the planar heater 24 and the holder 23 in the width direction via flanges 42 (see FIG. 3).

As described above, the planar heater 24 (the resistor pattern) disposed inside the loop of the fixing belt 21 directly heats the fixing belt 21. The outer circumferential surface of the fixing belt 21 heated by the planar heater 24 heats the toner image on the sheet P.

The output of the planar heater 24 is controlled based on the temperature of the planar heater 24 detected by the thermistor 40. The thermistor 40 directly contacts the planar heater 24 (or indirectly contacts the planar heater 24 via another member). The fixing device 20 according to the present embodiment does not include a temperature sensor that directly detects the surface temperature of the fixing belt 21. A controller controls the temperature of the planar heater 24 detected by the thermistor 40 to indirectly control the surface temperature (that is a fixing temperature) of the fixing belt 21 to a desired temperature.

With reference to FIG. 4, a pair of flanges 42 guides ends of the inner circumferential surface of the fixing belt 21 in the width direction of the fixing belt 21 such that the fixing belt 21 maintains a substantially cylindrical posture. Specifically, the two flanges 42 are made of a heat-resistant resin material and are held by both sides of the frame 60 in the width direction of the frame 60 of the fixing device 20 so that each of the flanges 42 can slide and move along each of the sides of the frame 60 in a direction forming the fixing nip. Each of the flanges 42 includes a guide 42a and a stopper. The guides 42a hold the fixing belt 21 to maintain the substantially cylindrical posture of the fixing belt 21. The stopper restricts motion or skew of the fixing belt 21 in the width direction of the fixing belt 21.

As illustrated in FIG. 3, the fixing device 20 includes pressing levers 52 of a pressing device 51. The pressing levers press the flanges 42 such that the fixing belt 21, the planar heater 24, and the holder 23 press the pressure roller 31. The flanges 42 are disposed to support both ends of the loop of the fixing belt 21 in the width direction except for portions facing both ends of the fixing nip so that the planar heater 24 can form the fixing nip. The inner circumferential surface of the fixing belt 21 is loosely contacted only by the planar heater 24 and the flanges 42 at respective ends of the fixing belt 21 in the width direction thereof. No other component, such as a belt guide, contacts the inner circumferential surface of the fixing belt 21 to guide the fixing belt 21 as it rotates.

The fixing device 20 includes the stay 30 that is disposed inside the loop of the fixing belt 21 so as to be in contact with the pressure roller 31 via the holder 23, the planar heater 24, and the fixing belt 21. The stay 30 reinforces the planar heater 24 forming the fixing nip (and the holder 23), enhancing the mechanical strength of the holder 23 and the planar heater 24. The stay 30 is assembled to the frame 60 (or the holder 23) by screw fastening or other fasteners.

The stay 30 receiving the pressure from the pressure roller 31 via the holder 23, the planar heater 24, and the fixing belt 21 prevents a disadvantage that the pressure from the pressure roller 31 largely deforms the planar heater 24 (and the holder 23) at the fixing nip. Preferably, the stay 30 is made of metal having an increased mechanical strength, such as stainless steel or iron, to achieve the above-described function.

The holder 23 may be made of resin or metal. Preferably, the holder 23 is made of resin that has rigidity to prevent the holder 23 from bending even if the holder 23 receives pressure from the pressure roller 31, and the resin preferably has heat resistance and thermal insulation. The resin may be liquid crystal polymer (LCP), polyamide imide (PAI), polyether sulfone (PES), polyphenylene sulfide (PPS), polyether nitrile (PEN), and polyether ether ketone (PEEK). The holder 23 according to the present embodiment is made of liquid crystal polymer (LCP).

With reference to FIG. 2, the pressure roller 31 as the pressure rotator includes a cored bar 32 serving as a shaft, an elastic layer 33 layered on the cored bar 32, and a conductive surface layer 34 layered on the elastic layer 33. The pressure roller 31 is driven and rotated counterclockwise in FIG. 2 by a drive motor 95.

The cored bar 32 as the shaft of the pressure roller 31 has a hollow structure made of metal (the conductive material) and extends in the axial direction. The elastic layer 33 of the pressure roller 31 is made of an insulating material such as silicone rubber foam, silicone rubber, or fluororubber.

The conductive surface layer 34 of the pressure roller 31 is thin and functions as a release layer. The conductive surface layer 34 is made of PFA or PTFE in which carbon is dispersed to have conductivity. The material of the conductive surface layer 34 has a tubular shape. The material of the conductive surface layer 34 is set on the elastic layer 33 so that the tube covers the elastic layer 33. Thermal processing is performed to form the conductive surface layer 34. The conductive surface layer 34 is described in more detail below with reference to FIG. 6.

The pressure roller 31 is pressed against the fixing belt 21 to form a desired nip (the fixing nip) between the fixing belt 21 and the pressure roller 31. As illustrated in FIG. 3, a gear 45 is attached to the pressure roller 31 and engages a driving gear of the drive motor so that the pressure roller 31 is driven and rotated counterclockwise in FIG. 2, that is, a direction indicated by the arrow in FIG. 2. Both ends of the pressure roller 31 in the axial direction are rotatably supported by the frame 60 of the fixing device 20 through bearings, respectively.

The fixing device 20 according to the present embodiment also includes the gear 65 as the ring, which is described in detail below.

A description is provided of a regular fixing process to fix the toner image on the sheet P, which is performed by the fixing device 20 having the construction described above.

When the controller in the image forming apparatus 100 receives a print instruction, the controller controls the power supply to supply the electric power to the planar heater 24 and controls the drive motor 95 to start rotating the pressure roller 31 in the direction indicated by the arrow in FIG. 2. Due to driving and rotating the pressure roller 31, friction between the pressure roller 31 and the fixing belt 21 at the fixing nip rotates the fixing belt 21 in a direction indicated by an arrow in FIG. 2.

After the fixing belt 21 rotates, the sheet P is fed from the sheet feeder 12, and the toner image is transferred onto the sheet P at the position of the transfer roller 9. As a result, the sheet P bears an unfixed toner image. As illustrated in FIG. 2, the sheet P bearing the unfixed toner image is conveyed in a direction indicated by an arrow Y10 while the sheet P is guided by the entrance guide plate and enters the fixing nip formed between the fixing belt 21 and the pressure roller 31 pressed against the fixing belt 21.

The planar heater 24 heats the fixing belt 21. The planar heater 24 and the holder 23 are reinforced by the stay 30 and pressed against the pressure roller 31. The heat in the fixing belt 21 and the pressure between the planar heater 24 and the pressure roller 31 fix the toner image on the surface of the sheet P. After the toner image is fixed on the surface of the sheet P, the sheet P is sent out from the fixing nip, and an exit guide plate guides the sheet P to be conveyed in a direction indicated by an arrow Y11 in FIG. 2.

The following describes the configuration and operation of the fixing device 20 in detail, which is characteristic of the image forming apparatus 100 according to the present embodiment.

As described above with reference to FIGS. 2 and 5, the fixing belt 21 includes the base layer 21a as the belt conductive layer having conductivity. In addition, the fixing belt 21 includes the belt surface layer 21b having the insulating property (or the belt surface layer having the medium resistance) directly layered on the base layer 21a (the belt conductive layer). In other words, the fixing belt 21 according to the present embodiment has a two layer structure including the base layer 21a as the belt conductive layer having conductivity and the belt surface layer 21b having the insulating property or the medium resistance and layered on the base layer 21a. The belt surface layer 21b has a resistance larger than the base layer 21a.

In particular, the fixing belt 21 is formed so that one end of the base layer 21a (the belt conductive layer) in the width direction that is a left end of the base layer 21a in FIG. 5 projects from one end of the belt surface layer 21b in the width direction, and the gear 65 as the ring is disposed on the above-described one end of the base layer 21a. In other words, the base layer 21a as the belt conductive layer having conductivity has a portion exposed that is one end of the base layer 21a in the axial direction of the pressure roller 31, and the gear 65 as the ring is disposed on the exposed portion.

The above-described one end of the base layer 21a (the belt conductive layer) projecting from the above-described one end of the belt surface layer 21b in the axial direction directly contacts the gear 65 as the ring described below (in other words, a contact portion is formed).

As a result, the belt surface layer 21b is layered on a part of the base layer 21a (the belt conductive layer) extending in the width direction (the lateral direction in FIGS. 5 and 6 and the axial direction) except for the contact portion on which the base layer 21a is in contact with the gear 65 described below. In other words, the belt surface layer 21b is directly laminated on the base layer 21a in a range extending in the width direction except for the exposed portion of the base layer 21a.

On the other hand, the pressure roller 31 as the pressure rotator includes the conductive surface layer 34 that has the conductivity and is in contact with the belt surface layer 21b of the fixing belt 21 as the fixing rotator to form the fixing nip. The pressure roller 31 has a roller body on which the elastic layer 33 and the conductive surface layer 34 are laminated on the cored bar 32. The cored bar 32 as the shaft of the pressure roller 31 projects from both ends of the roller body to be exposed. The roller body does not include both ends of the cored bar 32 that are exposed. The conductive surface layer 34 is formed in the roller body so as to be in contact with the surface of the fixing belt 21 at the fixing nip. In other words, the roller body includes the conductive surface layer 34 having an outer circumferential surface contacting the surface of the fixing belt 21 as the fixing rotator at the fixing nip.

As illustrated in FIGS. 5 and 6, the gear 65 as the ring is disposed on the cored bar 32 as the shaft of the pressure roller 31 as the pressure rotator of the fixing device 20. The gear 65 has conductivity and is grounded. At least a part of the gear 65 extends along an end face of the roller body. The gear 65 as the ring contacts and is electrically connected to the exposed portion of the base layer 21a (the belt conductive layer). The exposed portion of the base layer 21a is an end portion of the base layer 21a in the axial direction, and the belt surface layer 21b is not laminated on the exposed portion. The end portion forms the exposed portion not covered by the belt surface layer 21b. Accordingly, the gear 65 contacts and is electrically connected to the conductive surface layer 34 of the pressure roller 31 and the base layer 21a of the fixing belt 21 (the belt conductive layer).

Specifically, as illustrated in FIGS. 5 and 6, the gear 65 has a ring shape (in other words, a doughnut shape) and is made of a conductive material. However, the gear 65 does not have a complete ring shape. The gear 65 has multiple spur tooth-shaped projections on the entire outer peripheral portion of the gear 65 in the circumferential direction. The gear 65 is formed in a gear shape, similarly to a so-called spur gear. The gear 65 as the ring has a shape like a gear but does not function as a gear transmitting a driving force. The gear 65 functions as a conductor grounding the base layer 21a (the belt conductive layer) of the fixing belt 21 and the conductive surface layer 34 of the pressure roller 31.

The cored bar 32 of the pressure roller 31 is inserted into the gear 65. In other words, the gear 65 is disposed on the cored bar 32 of the pressure roller 31 so as to contact the base layer 21a (the belt conductive layer) of the fixing belt 21 and the end face of the roller body of the pressure roller 31. The cored bar 32 functions as the shaft of the end of the pressure roller 31. The gear 65 rotates in a predetermined direction (counterclockwise in FIG. 2) together with the pressure roller 31.

The gear 65 has an outer diameter (an addendum circle diameter) substantially equal to or slightly larger than the outer diameter of the roller body (that includes the elastic layer 33 and the conductive surface layer 34) of the pressure roller 31. The tooth of the gear 65 is in contact with the base layer 21a of the fixing belt 21, which is the exposed portion of the belt conductive layer of the fixing belt 21.

Even if the outer diameter (the addendum circle diameter) of the gear 65 is equal to the outer diameter of the roller body of the pressure roller 31, the tooth of the gear 65 contacts the base layer 21a (the belt conductive layer) and is electrically connected to the base layer 21a. This is because the belt surface layer 21b is extremely thin and the pressure roller 31 is pressed against the fixing belt 21 so as to deform the fixing belt 21 and the pressure roller 31.

The ring contacting the base layer 21a (the belt conductive layer) of the fixing belt 21 in the present embodiment does not have a perfect ring shape but has a gear shape (a spur gear shape in the present embodiment). The multiple gear teeth arranged at intervals in the circumferential direction intermittently contacts the base layer 21a. The ring having the multiple gear teeth is less likely to cause a contact failure such as a partial contact than the ring having a perfect ring shape and contacting the base layer 21a. As a result, the ring having the multiple gear teeth generates satisfactorily, stably, and relatively large contact pressure and stably electrically couples between the base layer 21a and the ring.

The gear 65 is press-fitted into the cored bar 32 to enhance conductivity (electrical connectivity) with the cored bar 32 as the shaft. In order to prevent the gear 65 from being displaced on the cored bar 32 in the width direction (the axial direction), the gear 65 may be bonded and fixed to the cored bar 32 by a conductive adhesive. As illustrated in FIG. 5, the gear 65 is grounded (earthed) via the cored bar 32. Specifically, the cored bar 32 is connected to a grounding wire including the frame 60 grounded via a resistor 68 (an electric resistance member). Thus, the gear 65 is favorably grounded.

The gear 65 is disposed outside a maximum sheet passing region M in the fixing device 20 (in other words, disposed in a non-sheet passing region). The maximum sheet passing region M is defined as a region in the width direction through which a sheet P having a maximum size that can be conveyed passes. As a result, the gear 65 does not contact the fixed image and does not affect the fixed image.

As described above, the fixing device 20 according to the present embodiment includes the gear 65 functioning as the conductor. The gear 65 is grounded and satisfactorily and electrically connected to the base layer 21a (the belt conductive layer) of the fixing belt 21 and the conductive surface layer 34 of the pressure roller 31. The above-described structure is less likely to accumulate electric charge in the fixing belt 21 and the pressure roller 31 and reduces the occurrence of an abnormal image such as an electrostatic offset caused by the electric charge accumulation.

The electrostatic offset occurs as follows in the fixing process. When the sheet P that bears the toner enters the fixing nip, the toner electrostatically moves and adheres to the fixing belt 21 as the fixing rotator. After the fixing belt 21 rotates once, the toner adhered to the fixing belt 21 adheres to the sheet P again. As a result, the electrostatic offset occurs.

The above-described movement of toner to the fixing belt 21 is caused by charge on the surfaces of the fixing belt 21 and the pressure roller 31. In the present embodiment, the toner is negatively charged. when the fixing belt 21 is positively charged, the toner receives an electrostatic adsorptive force from the fixing belt 21. When the pressure roller 31 is negatively charged, the toner receives an electrostatic repulsive force from the pressure roller 31. As a result, the toner adheres to the fixing belt 21.

To countermeasure the above-described phenomenon, in the fixing device 20 according to the present embodiment, the charge is removed from the base layer 21a (the belt conductive layer) of the fixing belt 21 and the conductive surface layer 34 of the pressure roller 31 as described above. As a result, the surfaces of the fixing belt 21 and the pressure roller 31 are less likely to be charged. Therefore, electrostatic offset is less likely to occur.

As illustrated in FIG. 6, the conductive surface layer 34 of the pressure roller 31 according to the present embodiment has a folded portion 34a forming one end of the roller body in the axial direction that is the left end of the pressure roller 31 in FIGS. 5 and 6. The gear 65 as the ring is disposed adjacent to the folded portion 34a.

The material of the conductive surface layer 34 of the pressure roller 31 is folded from an edge of the outer circumferential surface of the pressure roller 31 toward the center axis W of the pressure roller 31 to form the folded portion 34a. The folded portion 34a forms the whole of the end face of the roller body including the elastic layer 33 and the conductive surface layer 34 but may form a part of the end face of the roller body. The folded portion 34a has a shape in which the conductive surface layer 34 is folded but may not made by a manufacturing process that actually folds the material of the conductive surface layer 34. In particular, the conductive surface layer 34 in the present embodiment has a tubular shape substantially covering the entire outer peripheral surface of the elastic layer 33 and the end faces of the elastic layer 33.

The almost entire of the folded portion 34a contacts the end face of the gear 65 as the ring. In other words, one end of the conductive surface layer 34 in the width direction (in other words, one end in the axial direction) has a shape folded in the radial direction and extending along the end face of the elastic layer 33 as illustrated in FIGS. 5 and 6. The portion of the conductive surface layer 34 having the shape folded in the radial direction contacts the end face of the gear 65. As a result, the conductive surface layer 34 has the folded portion 34a folded from the edge of the outer circumferential surface toward the shaft in the radial direction of the shaft, and the folded portion 34a forms at least a part of the end face as a first end face of the roller body in the axial direction. In addition, the gear 65 as the ring is grounded and disposed on one end of the cored bar 32 as the shaft in the axial direction. The gear 65 has conductivity. The gear 65 as the ring has a second end face along the first end face of the roller body in the radial direction, and the second end face of the gear contacts at least a part of the folded portion 34a.

Bringing the folded portion 34a formed in the conductive surface layer 34 into contact with the end face of the gear 65 as described above, which is a relatively simple configuration, can obtain a sufficient contact area between the conductive surface layer 34 and the gear 65 without providing a complicated ground path.

As a result, the charge in the surface (the conductive surface layer 34) of the pressure roller 31 is sufficiently removed, and the occurrence of the abnormal image such as the electrostatic offset is sufficiently reduced.

The following describes a first modification.

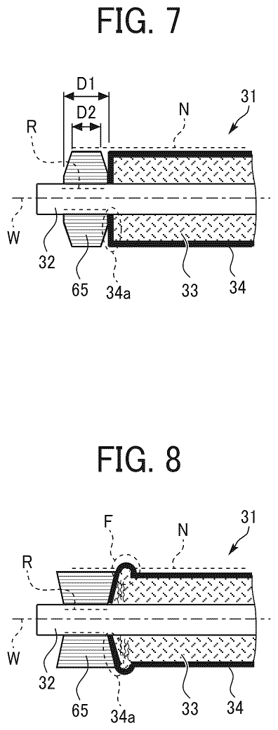

As illustrated in FIG. 7, the fixing device 20 according to the first modification includes the gear 65 that has an edge facing the roller body of the pressure roller 31. At a room temperature, the edge of the gear 65 as the ring is separated from an edge of the outer circumferential surface of the roller body to form a gap. The room temperature is typically from 15° C. to 28° C.

Specifically, the gear 65 in the first modification has a substantially drum shape in which a gear width D2 of an outer diameter portion is smaller than a gear width D1 of an inner diameter portion (D1>D2). In other words, the gear 65 as the ring includes a drum. The conductive surface layer 34 of the pressure roller 31 has a folded portion 34a formed as one end of the roller body in the axial direction. A part of the folded portion 34a adjacent to the shaft of the pressure roller 31 is in contact with the inner diameter portion having the gear width D1 of the gear 65 and is electrically connected to the gear 65.

The reason why the gear 65 has the above-described shape is as follows. In the fixing process (an actual use state), the fixing device 20 is used at a high temperature. The thermal expansion of the outer diameter portion of the gear 65 is likely to be larger than the thermal expansion of the inner diameter portion of the gear 65.

In particular, as illustrated in FIG. 7, the gear 65 as the ring in the fixing device 20 according to the first modification has the inner circumferential surface as the bonding portion R bonded to the cored bar 32 as the shaft via a conductive adhesive. The adhesive on the bonding portion R restricts the thermal expansion of the inner diameter portion of the gear 65. As a result, the thermal expansion of the outer diameter portion is larger than the thermal expansion of the inner diameter portion, and the gear width at the high temperatures becomes larger than that at the room temperature.

FIG. 8 is a sectional view of the gear 65 according to a comparative example. At the room temperature, the gear 65 according to the comparative example has a constant gear width from the inner diameter portion to the outer diameter portion. However, at the high temperature during the fixing process, the gear width of the outer diameter portion becomes larger than that of the inner diameter portion due to the thermal expansion. In such a case, the gear 65 having the gear width of the outer diameter portion increased by the thermal expansion presses the end face of the roller body of the pressure roller 31, which causes wrinkles at the end of the elastic layer 33 or a raised portion in an end of the conductive surface layer 34 (see a part F surrounded by a broken line in FIG. 8). Such phenomena damage the conductive surface layer 34 and the elastic layer 33, reduce the function as the pressure roller 31 forming the fixing nip N, and cause difficulty in grounding the conductive surface layer 34.

In contrast, the gear 65 in the fixing device 20 according to the first modification is designed to have the gear width D2 of the outer diameter portion set to be small in advance at the room temperature in anticipation of the gear width being increased due to the thermal expansion at the high temperature during the fixing process as described above. In other words, the fixing device 20 according to the first modification is designed to have a clearance for the thermal expansion of the outer diameter portion of the gear 65. As a result, the disadvantages described with reference to FIG. 8 are less likely to occur.

Also in the first modification, the part of the folded portion 34a in contact with the end face of the gear 65 gives a sufficient contact area between the conductive surface layer 34 and the gear 65, and thus the charge on the surface of the pressure roller 31 (in other words, the conductive surface layer 34) can be satisfactorily removed. In particular, the thermal expansion of the outer diameter portion of the gear 65 at the high temperature during the fixing process further causes the contact area between the conductive surface layer 34 and the gear 65 to be larger than the contact area under the room temperature illustrated in FIG. 7, and thus the above-described charge removing effect is more likely to be exhibited.

The following describes a second modification.

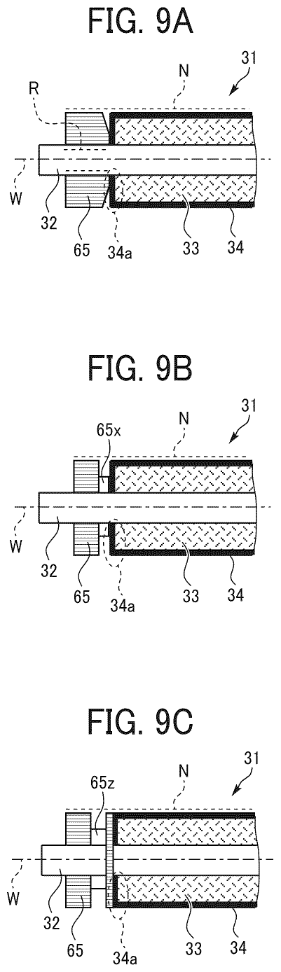

As illustrated in FIG. 9A, the fixing device 20 according to the second modification includes the gear 65 that is disposed on the pressure roller 31 and has the edge facing the roller body of the pressure roller 31. At the room temperature, the edge of the gear 65 as the ring is separated from the edge of the outer circumferential surface of the roller body to form the gap, which is the same as the embodiment illustrated in FIG. 7. However, the shape of the gear 65 illustrated in FIG. 9A is different from the drum shape illustrated in FIG. 7. The gear 65 has one end face facing the roller body and having a shape like the drum shape and the other end face (the left end face of the gear 65 in FIG. 9A) being flat and having a straight line in the cross section.

The gear 65 as the ring in another example of the second modification includes a small-diameter portion 65x facing the roller body of the pressure roller 31 as illustrated in FIG. 9B. The small-diameter portion 65x is sufficiently smaller than the outer diameter of the pressure roller 31 and does not contact the base layer 21a of the fixing belt 21. In other words, the gear 65 as the ring includes the small-diameter portion 65x as a portion facing the roller body, and the small-diameter portion 65x as the portion has a diameter smaller than a diameter of the roller body. An end face of the small-diameter portion 65x is in contact with the folded portion 34a of the conductive surface layer 34.

As still another example, the gear 65 as the ring has a groove at a position in the axial direction in the outer circumferential surface of the gear 65 as illustrated in FIG. 9C at the room temperature. The groove extends in a circumferential direction of the gear 65 as the ring. Specifically, the gear 65 has the groove in a medium part of the gear in the axial direction that is a width direction of the gear. In the example of FIG. 9C, the groove is relatively close to the end face of the roller body of the pressure roller 31. A bottom portion 65z of the groove is sufficiently smaller than the outer diameter of the pressure roller 31 and does not contact the base layer 21a of the fixing belt 21.

Since the gear 65 illustrated in each of FIGS. 9A to 9C has the clearance for the thermal expansion of the outer diameter portion of the gear 65, the disadvantages caused by the outer diameter portion of the gear 65 pressing the end face of the roller body of the pressure roller 31 is less likely to occur. As a result, the disadvantage of wrinkles occurring at the end of the elastic layer 33 and the disadvantage of the end of the conductive surface layer 34 rising are less likely to occur.

Also in the fixing device 20 as illustrated in each of FIGS. 9A to 9C, a part of or the entire of the folded portion 34a in contact with the end face of the gear 65 gives a sufficient contact area between the conductive surface layer 34 and the gear 65, and thus the electric charge on the surface of the pressure roller 31 (in other words, the conductive surface layer 34) can be satisfactorily removed.

The following describes a third modification.

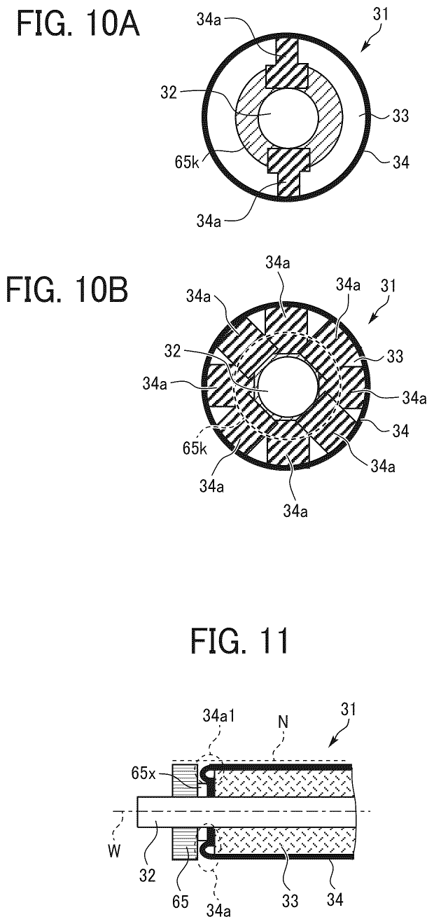

As illustrated in FIG. 10A, the conductive surface layer 34 of the pressure roller 31 in the fixing device 20 according to the third modification has multiple folded portions 34a separated in the circumferential direction so as not to overlap each other.

The multiple folded portions 34a may be formed when the material of the conductive surface layer 34 is spread on and attached to the elastic layer 33.

specifically, the conductive surface layer 34 illustrated in FIG. 10A has two folded portions 34a displaced from each other by 180° not to overlap each other. The above-described configuration provides stable and good contact (conduction) between the multiple folded portions 34a and the end face of the gear 65.

A comparative example is described with reference to FIG. 10B. As illustrated in FIG. 10B, overlapping multiple folded portions 34a generates a step between an overlapping portion and a non-overlapping portion, and the step is likely to prevent the gear 65 and the folded portions 34a from providing the stable and good contact (conduction).

The folded portion 34a illustrated in FIG. 10A has a portion contacting an end face contact portion 65k of the gear 65, and the portion is larger than another portion to increase the contact area between the end face contact portion 65k of the gear 65 and the folded portion 34a.

Also in the fixing device 20 according to the third modification, the folded portion 34a in contact with the end face of the gear 65 gives a sufficient contact area between the conductive surface layer 34 and the gear 65, and thus the charge on the surface of the pressure roller 31 (in other words, the conductive surface layer 34) can be satisfactorily removed.

The following describes a fourth modification.

As illustrated in FIG. 11, the pressure roller 31 in the fixing device 20 according to the fourth modification has a gap between the end face of the roller body and the folded portion 34a of the conductive surface layer 34 in a part 34a1 surrounded by a broken line in FIG. 11. The part 34a1 is close to the surface of the pressure roller 31 (the outer circumferential surface of the pressure roller 31).

In other words, the folded portion 34a in the fourth modification has a portion that is close to the outer circumferential surface of the roller body of the pressure roller 31 and not bonded to the end face of the roller body. The folded portion 34a has the portion separated from the end face of the roller body at a position close to the edge of the outer circumferential surface of the roller body in the axial direction. The folded portion 34a is bonded to the end face of the pressure roller 31 in a part other than the part 34a1 surrounded by the broken line (the part 34a1 forming the gap between the end face of the pressure roller 31). The part of the folded portion other than the part 34a1 contacts and is electrically connected to the small-diameter portion 65x of the gear 65.

The material of the conductive surface layer 34 is folded from the edge of the outer circumferential surface of the pressure roller 31 toward the center axis W of the pressure roller 31 to form the folded portion 34a in the fourth modification, and the folded portion 34a in the fourth modification forms a part of the end face of the roller body of the pressure roller 31 (the part close to the cored bar 32). A part of the gear 65 (the part close to the cored bar 32, the small-diameter portion 65x) extends along the end face of the roller body of the pressure roller 31 and is disposed on the cored bar 32.

Vertically folding the material of the conductive surface layer 34 from the edge of the outer circumferential surface of the pressure roller 31 to form the folded portion 34a may generate a protrusion (in other words, a bulge), and the protrusion is likely to damage the fixing belt 21. Not bonding the part of the folded portion 34a close to the outer circumferential surface of the roller body to the end face of the roller body and forming the gap can prevent the fixing belt 21 from being damaged.

Also in the fixing device 20 according to the fourth modification, the folded portion 34a in contact with the end face of the gear 65 gives a sufficient contact area between the conductive surface layer 34 and the gear 65, and thus the charge on the surface of the pressure roller 31 (in other words, the conductive surface layer 34) can be satisfactorily removed.

As described above, the fixing device 20 includes the planar heater 24 as the heater, the fixing belt 21 as the fixing rotator, and the pressure roller 31 as the pressure rotator. The planar heater 24 heats the fixing belt 21. The pressure roller 31 is pressed against the fixing belt 21 to form the fixing nip N through which the sheet P is conveyed. The pressure roller 31 includes the conductive surface layer 34 having conductivity. The conductive surface layer 34 is formed on the roller body of the pressure roller 31 to contact the surface of the fixing belt 21 at the fixing nip N. The gear 65 as the ring has conductivity and is grounded. The gear 65 is disposed on the cored bar 32 (as the shaft) of the pressure roller 31 such that at least a part of the gear contacts along the end face of the roller body. The conductive surface layer 34 has the folded portion 34a having the shape folded from the edge of the outer circumferential surface of the pressure roller 31 to the center axis of the pressure roller 31. The folded portion 34a forms a part or the whole of the end face of the roller body. The gear 65 is disposed on the end of the roller body in the axial direction of the pressure roller 31 that is the same as the width direction. The part or the whole of the folded portion 34a is in contact with the end face of the gear 65.

The above-described configuration can sufficiently remove the charge on the surface of the pressure roller 31.

In the above embodiments and modifications, the present disclosure is applied to the fixing device 20 including the planar heater 24 as the heater. However, the fixing device to which the present disclosure is applied is not limited to this. For example, the present disclosure may be applied to the fixing device including an electromagnetic induction coil as the heater.

In the above embodiments and the modifications, the present disclosure is applied to the fixing device 20 including the fixing belt 21 as the fixing rotator. However, the fixing device to which the present disclosure is applied is not limited to this. For example, the present disclosure may be applied to the fixing device including a fixing roller or a fixing belt stretched around multiple rollers as the fixing rotator.

In the above embodiments and modifications, the fixing belt 21 includes the base layer 21a as the belt conductive layer. Alternatively, the fixing belt 21 may include the belt surface layer 21b and a conductive elastic layer sequentially layered on the base layer 21a to form a three layer structure. In this case, the belt surface layer 21b is indirectly layered over the base layer 21a. The belt surface layer 21b directly or indirectly layered over the base layer 21a may be expressed as the belt surface layer over the base layer. The conductive elastic layer may be used as the belt conductive layer.

In the above embodiments and modifications, the fixing device includes the gear 65 as the ring. However, the ring does not necessarily have to be the gear. In addition, the ring does not necessarily have to be the spur gear. For example, the ring may be the helical gear.

In the above embodiments and modifications, the planar heater 24 as the heater serves as the nip formation pad and is pressed against the pressure roller 31 via the fixing belt 21 to form the fixing nip. However, the nip formation pad may not be the heater.

In the above embodiments and modifications, the gear 65 as the ring contacts the folded portion 34a of the pressure roller 31 and the base layer 21a of the fixing belt 21 to form the grounding path. However, the gear 65 as the ring may contact the folded portion 34a of the pressure roller 31 to form the grounding path, and the base layer 21a of the fixing belt 21 may form another grounding path.

The above-described configurations also provide similar effects to those of the above-described embodiments and the modifications.

Note that embodiments of the present disclosure are not limited to the above-described embodiments, and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

In the present description, the term “sheet” is defined as any sheet-like recording medium including all conveyed objects, such as typical paper, coated paper, label paper, overhead projector (OHP) transparency, or a film sheet.

Aspects of the present disclosure may be, for example, as follows.

### First Aspect

In a first aspect, a fixing device includes a fixing rotator, a heater heating the fixing rotator, a pressure roller pressed against the fixing rotator to form a nip through which a sheet is conveyed, and a ring. The pressure roller includes a roller body with a conductive surface layer. The conductive surface layer has conductivity and contacts the surface of the fixing rotator at the nip. The ring has conductivity and is grounded. The ring is disposed on the shaft of the pressure roller such that at least a part of the ring extends along an end face of the roller body. The conductive surface layer has a folded portion folded from an edge of an outer circumferential surface of the roller body to the center axis of the roller body such that the folded portion forms a part or the whole of the end face of the roller body. The folded portion is in one end portion of the roller body in a width direction, the one end facing the ring. The part or the whole of the folded portion is in contact with the end face of the ring.

### Second Aspect

In a second aspect, the fixing device according to the first aspect includes a fixing belt as the fixing rotator. The fixing belt consists of a belt conductive layer with conductivity and a belt surface layer with insulating properties or medium resistance. The belt surface layer is directly or indirectly layered on part of the belt conductive layer, except for an exposed portion at the end of the belt conductive layer in the width direction. The end of the belt conductive layer is closer to the ring than the other end in the width direction. The ring contacts and is electrically connected to the exposed portion of the belt conductive layer.

### Third Aspect

In a third aspect, the ring in the fixing device according to the second aspect has a gear shape, and a tooth of the gear shape is in contact with the exposed portion of the belt conductive layer.

### Fourth Aspect

In a fourth aspect, the ring in the fixing device according to any one of the first to third aspects has an edge facing the roller body and is configured to form a gap between the edge of the ring and the edge of the outer circumferential surface of the roller body at a room temperature.

### Fifth Aspect

In a fifth aspect, the ring in the fixing device according to the fourth aspect has a substantially drum shape.

### Sixth Aspect

In a sixth aspect, the ring in the fixing device according to the fourth aspect includes a small-diameter portion facing the roller body.

### Seventh Aspect

In a seventh aspect, the ring in the fixing device according to any one of the first to the third aspects has a groove formed in a part of an outer circumferential surface in a width direction at a room temperature.

### Eighth Aspect

In an eighth aspect, the ring in the fixing device according to any one of the first to seventh aspects has an inner circumferential surface bonded to the shaft.

### Ninth Aspect

In a ninth aspect, the fixing device according to any one of the first to eighth aspects includes another folded portion that is separated from the folded portion in a circumferential direction of the end face of the roller body and does not overlap the folded portion.

### Tenth Aspect

In a tenth aspect, the folded portion in the fixing device according to any one of the first to ninth aspects is configured to form a gap between the end face of the roller body and a part of the folded portion close to the edge of the outer circumferential surface of the roller body.

### Eleventh Aspect

In an eleventh aspect, an image forming apparatus includes the fixing device according to any one of the first to tenth aspects.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a fixing rotator;
a heater to heat the fixing rotator;
a pressure roller:
pressed against the fixing rotator to form a nip through which a sheet is conveyed; and
including:
a shaft extending in an axial direction; and
a roller body including a conductive surface layer having an outer circumferential surface contacting a surface of the fixing rotator at the nip,
the conductive surface layer having a folded portion folded from an edge of the outer circumferential surface toward the shaft in a radial direction of the shaft, and
the folded portion forming at least a part of a first end face of the roller body in the axial direction; and
a ring:
grounded and disposed on the shaft; and
having conductivity and a second end face along the first end face in the radial direction and contacting at least a part of the folded portion.

2. The fixing device according to claim 1,
wherein the fixing rotator includes an endless belt including:
a belt conductive layer; and
a belt surface layer over a part of the belt conductive layer except for an end portion of the belt conductive layer in the axial direction, the end portion forming an exposed portion not covered by the belt surface layer,
the belt surface layer has a higher resistance than the belt conductive layer, and
the ring contacts and is electrically connected to the exposed portion of the belt conductive layer.

3. The fixing device according to claim 2,
wherein the ring has a gear having a tooth in contact with the exposed portion of the belt conductive layer.

4. The fixing device according to claim 1,
wherein the ring has an edge facing the roller body, and
the edge of the ring is separated from the edge of the outer circumferential surface of the roller body to form a gap at a room temperature.

5. The fixing device according to claim 4,
wherein the ring has a drum.

6. The fixing device according to claim 4,
wherein the ring includes a portion facing the roller body, and
the portion has a diameter smaller than a diameter of the roller body.

7. The fixing device according to claim 1,
wherein the ring has a groove extending in a circumferential direction of the ring in an outer circumferential surface of the ring at a room temperature.

8. The fixing device according to claim 1,
wherein the ring has an inner circumferential surface bonded to the shaft.

9. The fixing device according to claim 1,
wherein the conductive surface layer has, in addition to the folded portion, another folded portion separated from the folded portion in a circumferential direction of an end face of the roller body in the axial direction so as not to overlap the folded portion.

10. The fixing device according to claim 1,
wherein the folded portion has a portion separated from an end face of the roller body in the axial direction at a position close to the edge of the outer circumferential surface of the roller body.

11. An image forming apparatus comprising the fixing device according to claim 1.
